(19) United States
(12) Patent Application Publication
(10) Pub. No.: US 2025/0182493 A1
(43) Pub. Date: Jun. 5, 2025

(54) System and Method for Vehicle Identification and Tracking

(71) Applicant: Eagle Eye Networks, Inc., Austin, TX (US)

(72) Inventors: Juan Rodriquez, Austin, TX (US); Hunter Dunbar, Austin, TX (US); Sankaranarayanan Parameswaran, Bangalore (IN); Ranjith Parakkal, Bangalore (IN); Dossan George, Kerala (IN); Bhaskar C, Bangalore (IN); Deval Shah, Bangalore (IN); Naman Mishra, Bangalore (IN)

(73) Assignee: Eagle Eye Networks, Inc., Austin, TX (US)

(21) Appl. No.: 19/051,364

(22) Filed: Feb. 12, 2025

Related U.S. Application Data
(63) Continuation of application No. 17/511,554, filed on Oct. 27, 2021.
(60) Provisional application No. 63/159,268, filed on Mar. 10, 2021.

(51) Int. Cl. G06V 20/56; B60W 40/08; G06F 18/00; G06F 18/214; G06V 20/62

(52) U.S. Cl. CPC G06V 20/56; B60W 40/08; G06F 18/00; G06F 18/2148; G06V 20/62; B60W 2420/403

(57) ABSTRACT

Embodiments identify vehicles on arrival and match departing vehicles to their corresponding arrival event. The matching process uses primarily optical inputs. The system uses at least one camera to capture not only the vehicle license plate but also the visual features. A “signature” formed out of the optical features of the vehicle is compared against the pre-generated signatures of vehicles in a whitelist, and the best match is identified. The “signature” for each departing vehicle is compared against all signatures of vehicles that arrived. A plurality of filters reduce the possible matching candidates based on factors like license plate based edit distance, location information of vehicle owner. Synchronizing a database in each local processing unit (LPU) with a central database enables signature from images from sites that have good license plate reads, to assist in authentication in other sites where the reads are lower quality.

### CROSS-REFERENCE TO RELATED APPLICATIONS

This application is a continuation of U.S. application Ser. No. 17/511,554 filed Oct. 27, 2021, and claims the benefit of U.S. Provisional Application No. 63/159,268 filed Mar. 10, 2021.

### BACKGROUND

### Technical Field

The disclosure relates to a system and method of training a machine learning module of an edge device for image processing and verification. In particular, the present invention relates to a system and apparatus for performing vehicle identification for authentication.

### Background of the Invention

A variety of concerns, including health and speed of operation may benefit from touch-free authentication of vehicles. A variety of methods have been used in this regard, each with their own benefits and drawbacks. Some approaches, like license plate recognition (or LPR) involve the usage of sensors and imaging. These approaches satisfy constraints of quick response rate, but there are drawbacks resulting from issues ranging from occlusion (e.g., cycle rack fitted on the back of a car) to the readability of license plates. Other methods like QR Code Scanning are also popular. Such methods enjoy high accuracy but suffer from slow response. Another important consideration is the ability to operate even without gates or boom-barriers.

### SUMMARY

Embodiments disclosed herein include methods to identify vehicles on arrival, match existing vehicles to their corresponding arrival event, and conduct a pre-census of vehicles which may be discovered at a later point in time.

The identification and matching processes may use visual inputs from cameras. In an embodiment, additional cues, (e.g., location information from a mobile application present in a vehicle owner's phone) may augment the process. The system uses at least one camera to capture not only the vehicle license plate but also the visual features. The features can be captured from both rear and front of the vehicle. On arrival, the set of images from all cameras, together with the license plate information, may be used to identify the vehicle from one of several white-listed vehicles (e.g., monthly parkers). A signature formed out of the visual features of the vehicle is compared against the pre-generated signatures of vehicles in the whitelist, and the best match is identified. At departure, the signature for the vehicle is compared against all signatures of vehicles that arrived. The invention deploys a plurality of filters to reduce the possible matching candidates based on factors like license plate-based edit distance (of current vehicle and potential candidates) and location information of vehicle owner (if available), amongst other cues. The invention auto-onboards the signature of whitelisted vehicles. Sometimes the vehicle license plate is read correctly with high confidence. Such occasions are used to obtain the vehicle image for signature computation and storage in the database. This is then used to assist during other occasions when the vehicle license plate is not read correctly. The database in each local processing unit (LPU) is synchronized with a central database so signatures from images from sites that have good license plate reads can be used to assist in authentication of same vehicle in other sites where the reads are not as good.

The system includes at least one camera, a local processing unit, a cloud processing unit, and a plurality of vehicle signature database services. The system includes cameras having a compute unit, or sending data to a separate local processing unit (LPU). Optimally, one camera oriented at the rear of a vehicle performs LPR and obtains the vehicle features. Visual authentication solves the problem of both gated and gateless garages.

To overcome limited effectiveness of license plate usage, analyzing visual features of a vehicle (also referred to as a vehicle signature) picks up many other distinctive characteristics in addition to license plate information. To distinguish between vehicles having similar visual features and no other salient features, the invention explores and limits the search space to match or authenticate vehicles by using other methods to timewise restrict the list of candidates which occupy or transit. Another unique sub-signature is based on the edit distance between plates, and a signature of character positions within the license plate. A semi-automated approach onboards the details of whitelisted vehicles.

The system includes one or more cameras, wherein each camera either has a compute unit in the camera unit or sends data to a separate local processing unit (LPU). In one embodiment, there can be just one camera looking at the rear of a vehicle performing LPR and obtaining the vehicle features. In another embodiment, there can be two cameras, one looking at the rear of the vehicle and another looking at the front of the vehicle. In yet another embodiment, there can be more than two cameras, with a first camera looking at the front of the vehicle, a second camera looking the rear of the vehicle and other cameras looking at the sides of the vehicle. Visual authentication is to be the primary mode of authentication to solve the problem of both gated and gateless garages. While it can be appreciated by those skilled in the art that license plate recognition (LPR) serves to be a key visual authenticator for vehicles, there are plenty of statistical challenges that limit effectiveness of license plate usage, for example, broken plates, imperfect imaging due to lighting conditions, temporary plates and obstructions over license plates (e.g., a cycle rack) to name a few. Hence, in some embodiments, other visual features of a vehicle (termed henceforth in the document as a vehicle signature) are included in addition to using the license plate information. This picks up many other distinctive features of the vehicle in addition to license plate. Even using vehicle signature is prone to errors, especially amongst vehicles having similar visual features and no other salient features. In another aspect of this invention, the search space to match or authenticate vehicles is reduced using other methods. In one embodiment, location information (e.g., GPS) is used to timewise restrict the list of candidates who may have arrived or departed. In another embodiment, a unique sub-signature based on license plate information is used, for example the edit distance between license plates, or a signature of character positions within the license plate.

Embodiments provide an effective method for onboarding the details of whitelisted vehicles and avoid the need to have onboarding done through user involvement and auto-onboards users using a semi-automated approach.

Techniques of the present invention can provide substantial beneficial technical effects. For example, one or more embodiments may provide for low cost and low performance edge apparatus with low connectivity performing narrow image processing tasks by machine learning. These and other features and advantages of the present invention will become apparent from the following detailed description of illustrative embodiments thereof, which is to be read in connection with the accompanying drawings.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which reference will be made to embodiments of the invention, example of which may be illustrated in the accompanying figure(s). These figure(s) are intended to be illustrative, not limiting. Although the invention is generally described in the context of these embodiments, it should be understood that it is not intended to limit the scope of the invention to these particular embodiments. Preferred embodiments of the present invention will be described below in more detail, with reference to the accompanying drawings:

FIG. 1 shows an exemplary computing architecture suitable for performing the methods of the processes of the invention as executable instructions;

FIG. 2 shows a flow chart, depicting one embodiment of a method for identifying a vehicle arriving;

FIG. 3 shows a flow chart, depicting one embodiment of a method for identifying a vehicle arriving;

FIG. 4 shows a block diagram of embodiments of the system architecture;

FIG. 5 shows a block diagram of functions of a local processing unit;

FIG. 6 shows a block diagram of functions of a cloud processing unit; and

FIG. 7 shows an exemplary overall flow of interactions, data flows, and events in performing the invention.

### DETAILED DESCRIPTION

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a computer readable storage medium with computer usable program code for performing the method steps indicated. Furthermore, one or more embodiments or elements thereof can be implemented in the form of a system (or apparatus) including a memory, and at least one processor that is coupled to the memory and operative to perform exemplary method steps. Yet further, in another aspect, one or more embodiments or elements thereof can be implemented in one or more of the method steps described herein, wherein the method may be performed by hardware, software stored in a computer readable storage medium (or multiple such media) and implemented on a hardware processor, or a combination of hardware and software to implement the specific techniques set forth herein.

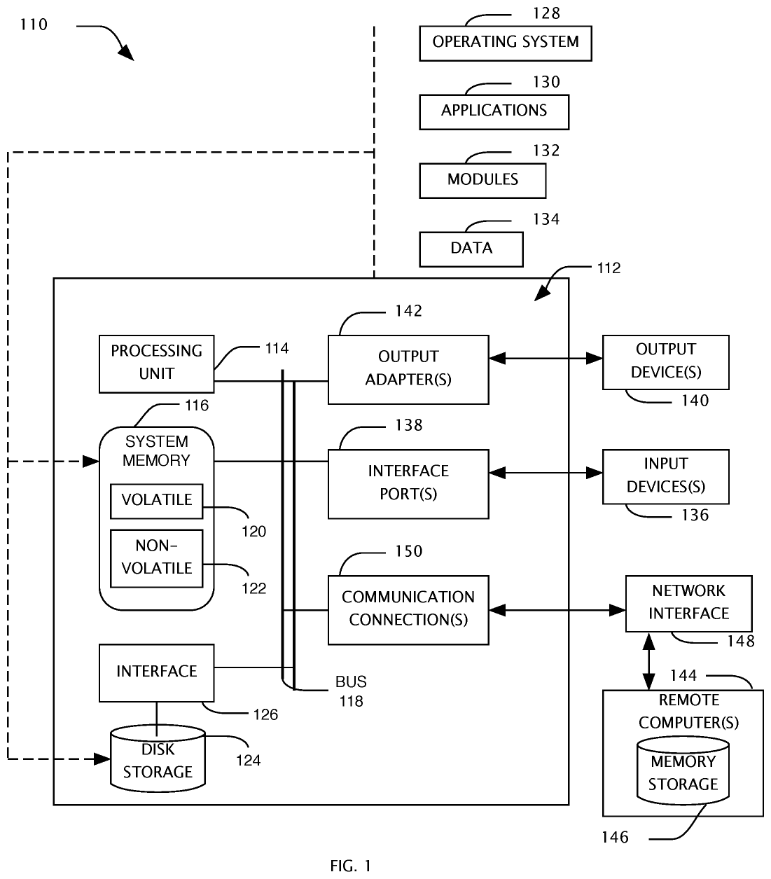

FIG. 1 depicts a computer system that may be useful in implementing one or more aspects and/or elements of the invention, also representative of a cloud computing node according to an embodiment of the present invention. Referring now to FIG. 1, cloud computing node 110 is only one example of a suitable cloud computing node and is not intended to suggest any limitation as to the scope of use or functionality of embodiments of the invention described herein. Regardless, cloud computing node 110 is capable of being implemented and/or performing any of the functionalities set forth hereinabove.

In cloud computing node 110 there is a computer system/server 112, which is operational with numerous other general purpose or special purpose computing system environments or configurations. Examples of well-known computing systems, environments, and/or configurations that may be suitable for use with computer system/server 112 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like exemplary represented as at least one remote computer 144 having memory storage 146 for at least one of data and instructions.

Computer system/server 112 may be described in the general context of computer system executable instructions, such as applications 130 program modules 132, being platformed by a computer operating system 128 and engaged in at least one of receiving, transforming, and transmitting data 134. Generally, program modules 132 may include routines, programs, objects, components, logic, data structures, etc., that perform particular tasks or implement particular abstract data types. Computer system/server 112 may be practiced in distributed cloud computing environments where tasks are performed by remote processing devices that are linked through a communications network. In a distributed cloud computing environment, program modules may be located in both local and remote computer system storage media including memory storage devices 146.

As shown in FIG. 1, computer system/server 112 in cloud computing node 110 is shown in the form of a general-purpose computing device. The components of computer system/server 112 may include, but are not limited to, one or more processors or processing units (processors, cores) 114, system memory 116, and bus 118 that couples various system components including system memory 116 to processor 114. Processors, cores, and units may also communication with one another through shared memory service and inter-process communication (IPC) in some embodiments.

Bus 118 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 112 typically includes a variety of computer system readable media. Such media may be any available media that is accessible by computer system/server 112, and it includes both volatile and non-volatile media, removable and non-removable media.

System memory 116 can include computer system readable media in the form of volatile memory, such as random-access memory (RAM) 120 and/or cache memory as well as non-volatile devices 122 for configuration and initialization (microcode). Computer system/server 112 may further include other removable/non-removable, volatile/non-volatile computer system storage media. By way of example only, storage system can be provided for reading from and writing to a non-removable, non-volatile magnetic or optical media (typically called a “hard drive” or disk storage 124). Such a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 118 by one or more data media interfaces 126. As will be further depicted and described below, memory 116 may include at least one program product having a set (e.g., at least one) of program modules that are configured to carry out the functions of embodiments of the invention.

Application/program/utility 130, having a set (at least one) of program modules 132, may be stored in memory 116 by way of example, and not limitation, as well as an operating system, one or more application programs, other program modules, and program data. Each of the operating system, one or more application programs, other program modules, and program data or some combination thereof, may include an implementation of a networking environment.

Program modules 132 generally carry out the functions and/or methodologies of embodiments of the invention as described herein.

Computer system/server 112 may also communicate with one or more external devices. In an embodiment, coupled to the bus 118 are output adapters 142, interface ports 138, and communication connections 150. Input devices 136 such as a keyboard, a pointing device, a touch display, etc. may be coupled to the system via the interface port(s) 138. One or more devices that enable a user to interact with computer system/server 112 or receive the results of performing a method on output devices 140 such as printers, speaker, video displays, projectors, actuators through an output adapter 142. Other systems and networks may be coupled through a communications connection 150 and/or any devices (e.g., network card, modem, etc.) that enable computer system/server 112 to communicate with one or more other computing devices. Such communication can occur via Input/Output (I/O) interfaces 138 142. Still yet, computer system/server 112 can communicate with one or more networks such as a local area network (LAN), a general wide area network (WAN), and/or a public network (e.g., the Internet) via network interface 148. As depicted, network interface communicates with remote computer server 144 and may access memory storage 146 at remote computers 144. It should be understood that although not shown, other hardware and/or software components could be used in conjunction with computer system/server 112. Examples include, but are not limited to: microcode, device drivers, redundant processing units, and external disk drive arrays, RAID systems, tape drives, and data archival storage systems, etc.

Thus, one or more embodiments can make use of software running on a general-purpose computer or workstation. With reference to FIG. 1, such an implementation might employ, for example, a processor 114, a memory 116, and an input/output interface to output devices 140 (a display and external device(s) such as a keyboard, a pointing device, or the like). The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory) 120, ROM (read only memory) aka non-volatile 122, a fixed memory device (for example, hard drive 124), a removable memory device (for example, diskette), a flash memory and the like. In addition, the phrase “input/output interface” as used herein, is intended to contemplate an interface to, for example, one or more mechanisms for inputting data to the processing unit (for example, a mouse), and one or more mechanisms for providing results associated with the processing unit (for example, a printer). The processors, memory, and input/output interface can be interconnected, for example, via bus 118 as part of a data processing unit 112. Suitable communication connections 150, for example via bus 118, can also be provided to a network interface 148, such as a network card, which can be provided to interface with a computer network, and to a media interface, such as a diskette or CD-ROM drive, which can be provided to interface with suitable media.

Accordingly, computer software including instructions or code for performing the methodologies as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 114 coupled directly to system memory elements 116 or indirectly through a system bus 118. The memory elements can include volatile memory 120 employed during actual implementation of the program code, bulk storage, and cache memories which provide temporary storage of at least some program code in order to reduce the number of times code must be retrieved from bulk storage during implementation, and non-volatile memory 122 employed to configure and initialize the processing unit during “bootup”.

Input/output or I/O devices (including but not limited to keyboards, displays, pointing devices, and the like) can be coupled to the system either directly or through intervening I/O controllers. Network interface(s) 148 may also be coupled to the system to enable the data processing system to become coupled to other data processing systems or remote printers or storage devices through intervening private or public networks. Modems, cable modem and Ethernet cards are just a few of the currently available types of network interfaces.

As used herein, including the claims, a “server” includes a physical data processing system running a server program. It will be understood that such a physical server may or may not include a display and keyboard.

It should be noted that any of the methods described herein can include an additional step of providing a system comprising distinct software modules embodied on a computer readable storage medium; the modules can include, for example, any or all of the appropriate elements depicted in the block diagrams and/or described herein; by way of example and not limitation, any one, some or all of the modules/blocks and or sub-modules/sub-blocks described. The method steps can then be carried out using the distinct software modules and/or sub-modules of the system, as described above, executing on one or more hardware processors or processor cores. Further, a computer program product can include a non-transitory computer-readable storage medium with encoded machine executable instructions adapted to be implemented to carry out one or more method steps described herein, including the provision of the system with the distinct software modules.

One example of a user interface that could be employed in some cases is hypertext markup language (HTML) code served out by a server or the like, to a browser of a computing device of a user. The HTML is parsed by the browser on the user's computing device to create a graphical user interface (GUI). Another example of a well-known user interface is HTTP including but not limited to GET, POST, PUT, PATCH, and DELETE, the five most common HTTP methods for retrieving data from and sending data to a server.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Embodiments may identify vehicles on arrival and match departing vehicles to their corresponding arrival vehicle. The matching process uses primarily optical inputs. The system uses at least one camera to capture not only the vehicle license plate information but also the visual features. A “signature” formed out of the optical features of the vehicle is compared against the pre-generated signatures of vehicles in a whitelist, and the best match is identified. The signature for each departing vehicle is compared against all signatures of vehicles that arrived. A plurality of filters reduce the possible matching candidates based on factors like license plate based edit distance and location information of a vehicle owner. Synchronizing a database in each local processing unit (LPU) with a central database enables signature from images from sites that have good license plate reads, to assist in authentication at other sites where the reads are lower quality.

General methods to authenticate vehicles may comprise one or more manual or electronic methods (e.g., manual entry, RFID, QR Code, license plate reading). These have issues with setting up of infrastructure (barrier/gate), speed of execution, or being error prone. Accordingly, to solve these problems and more, embodiments disclosed herein may identify vehicles on arrival and match a departing vehicle to a vehicle that previously arrived.

The identification and matching process may be accomplished using purely visual inputs (cameras) and may be optionally facilitated by usage of additional cues (e.g., location information from a mobile application present in a vehicle owner's phone).

The system uses one or more cameras to capture not only the vehicle license plate but also the visual features. The features can be captured from either/both the rear and the front of the vehicle. The set of images from all cameras, together with the license plate information, may be used to identify the vehicle from one of several whitelisted vehicles. To facilitate this process, a signature formed out of the visual features of the vehicle is compared against the pre-generated signatures of vehicles in the whitelist, and the best match is identified. Upon departure, the signature for the vehicle is compared against all signatures of vehicles that arrived.

One of the key steps of this invention is to deploy a set of filters to reduce the possible matching candidates based on factors like license plate-based edit distance (of current vehicle and potential candidates) and location information of vehicle owner (if available), amongst other cues.

Embodiments may also onboard the signatures of whitelisted vehicles. Sometimes the vehicle license plate is read correctly with very high confidence. Such occasions are used to obtain the vehicle image for signature computation and storage in the database. This information may then be used to assist during other occasions when the vehicle license plate is not read correctly. Further, the database in the local processing unit (LPU) is synchronized with a central database. Signatures from images from sites that have good license plate reads can be used to assist in authentication of a vehicle at another site where the reads are not good.

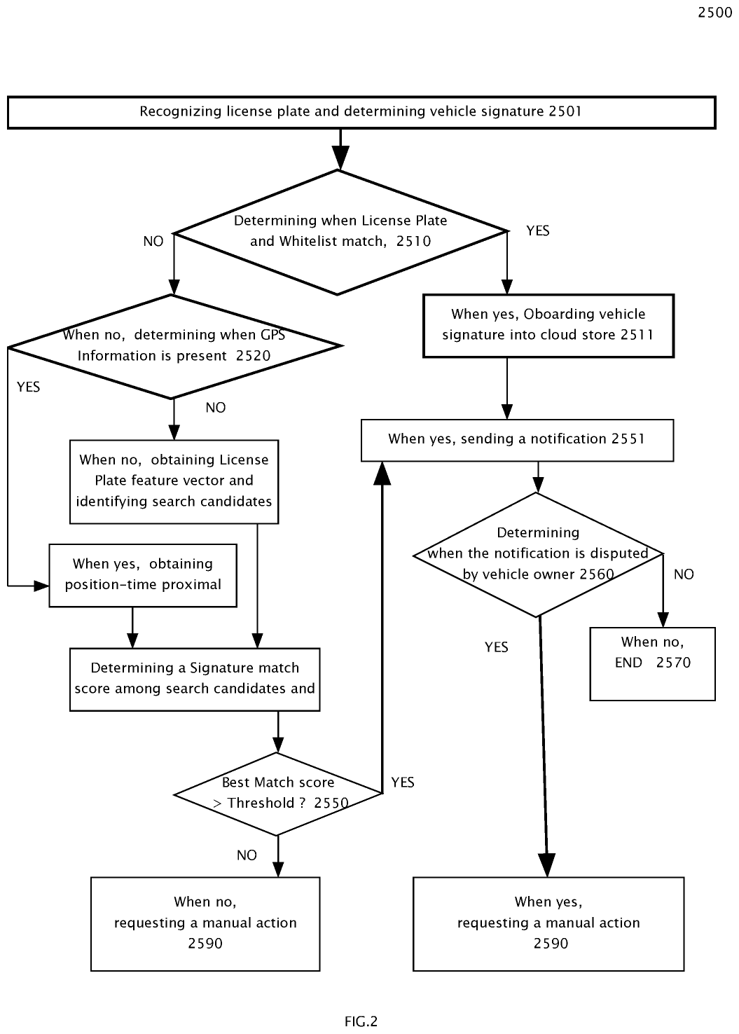

Referring to FIG. 2, flow diagram 2500 depicts one embodiment of a method for identifying arriving vehicles.

At step 2501, embodiments read a license plate and determine a vehicle signature.

At step 2510, embodiments determine whether license plate information read from a vehicle matches information for a whitelisted vehicle.

If, at step 2510, embodiments determine license plate information read from a vehicle matches information for a whitelisted vehicle, then at step 2511, the method includes onboarding a vehicle signature into a cloud store and, at step 2551, sending a notification.

If, at step 2510, embodiments determine license plate information read from a vehicle does not match information for a whitelisted vehicle, then at step 2520, the method includes determining when location information (e.g., global positioning satellites or GPS coordinates) is present.

If, at step 2510, embodiments determine license plate information read from a vehicle matches information for a whitelisted vehicle, then at step 2521, the method includes obtaining position-time proximal candidates.

If, at step 2510, embodiments determine license plate information read from a vehicle does not matches information for a whitelisted vehicle, then at step 2530, the method includes obtaining a license plate feature vector and identifying search candidates.

At step 2540, the method includes determining a signature match score among search candidates and proximal candidates.

At step 2550, the method includes determining whether a best match score exceeds a threshold.

If, at step 2550, embodiments determine a best match score does not exceed a threshold, then at step 2590, the method includes requesting a manual action.

If, at step 2550, embodiments determine a best match score does not exceed a threshold, then at step 2551, the method includes sending a notification.

At step 2560, the method may include determining whether the notification is disputed by a vehicle owner.

If, at step 2560, embodiments determine the notification is not disputed by a vehicle owner, then at step 2570, the process ends.

If, at step 2560, embodiments determine the notification is not disputed by a vehicle owner, then at step 2590, the process includes requesting a manual action.

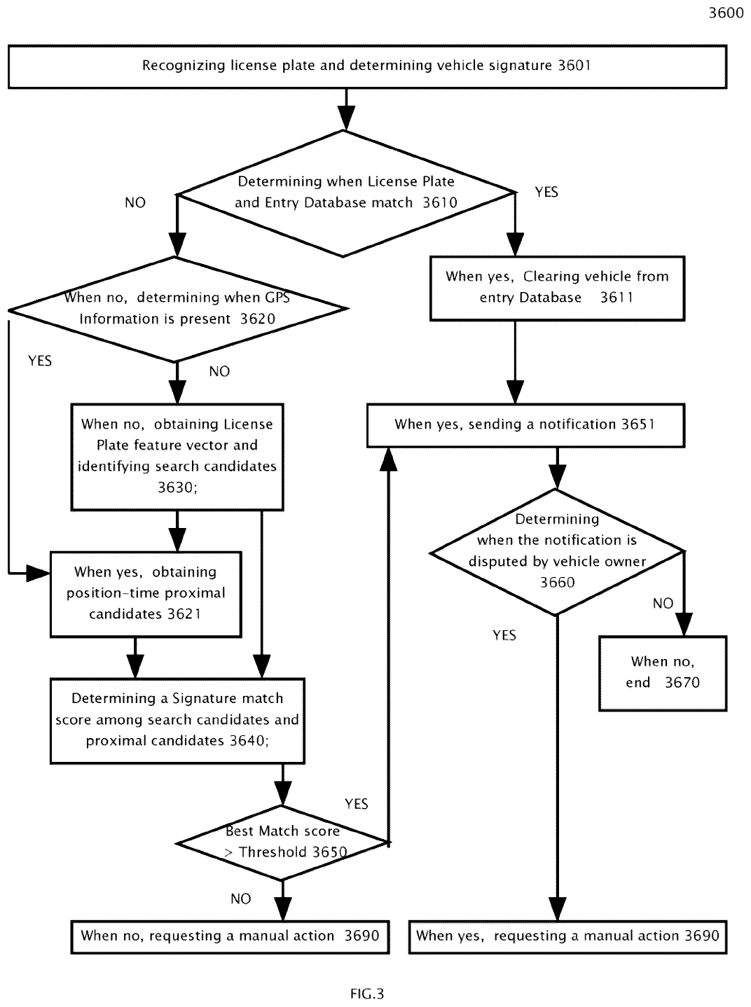

FIG. 3 depicts a flowchart of one embodiment of a method for identifying departing vehicles.

At step 3601, the method includes recognizing a license plate and determining a vehicle signature.

At step 3610, the method includes determining whether the license plate information matches information in a first database.

If, at step 3610, the license plate information matches information in a first database, then the method includes clearing the vehicle information from the first database at step 3611 and sending a notification at step 3651.

If, at step 3610, the license plate information does not match information in the first database, determining, at step 3620, when location information (e.g., GPS coordinates) is present.

If, at step 3620, embodiments determine location information is present, then at step 3621, the method includes obtaining position-time proximal candidates.

If, at step 3620, embodiments determine location information is not present, then at step 3630, the method includes obtaining license plate feature vector and identifying search candidates.

At step 3640, determining a signature match score among search candidates and proximal candidates.

At step 3650, determining when a best match score exceeds a threshold.

If, at step 3650, a best match score is less than or equal to a threshold score, then at step 3690, the method includes requesting a manual action.

If, at step 3650, a best match score exceeds a threshold score, then at step 3651, the method includes sending a notification.

At step 3660, determining whether the notification is disputed by a vehicle owner.

If, at step 3660, the notification is not disputed by the vehicle owner, then as step 3670, the process ends.

If, at step 3660, the notification is disputed by the vehicle owner, then at step 3690, requesting a manual action.

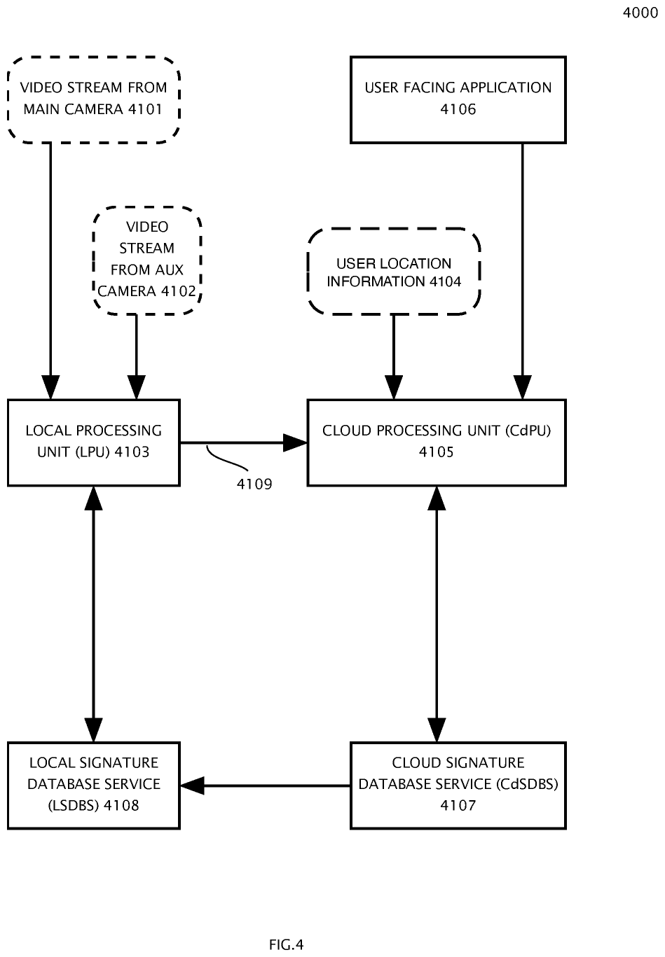

Referring to FIG. 4, a block diagram of an embodiment of a system 4000, wherein a local processing unit (LPU) 4103 executes instructions to perform license plate reads (LPR) and determine a vehicle signature as an “edge” device. System 4000 may be set up to reduce the delay between the arrival/departure of the vehicle and physical action to be performed on site (e.g., opening of boom barrier). LPU 4103 transmits event information 4109 to cloud processing unit (CdPU) 4105 which event information includes images from main and auxiliary cameras 4101, 4102, license plate reads, timestamps, indication of match/mismatch with whitelisted database. It also transmits signature information in the case of a successful match with a whitelisted vehicle.

CdPU 4105 has two fundamental tasks. In the event of an event from any LPU 4109 which is already not whitelisted, CdPU 4105 evaluates the vehicle signature and validates it against onboarded vehicle signatures from users if already present. The other task involves evaluation and storage of vehicle signatures from user facing application 4106.

User location information 4104 can be captured from any mobile device that supports obtaining and sharing location information using one or more modalities like GPS, WiFi, Bluetooth etc.

User application 4106 can execute on any computing device associated with the user. It captures vehicle images from the user and sends these to CdPU 4105 for validation and user onboarding. After the user is onboarded, at least one vehicle signature for the given user/vehicle is available in cloud signature database service (CdSDBS) 4107.

CdSDBS 4107 aggregates signatures of all vehicles across all sites. Local signature database service (LSDBS) 4108 maintains local copies of all whitelisted vehicle signatures in addition to whitelisted license plate readings on the edge for fast response on-site.

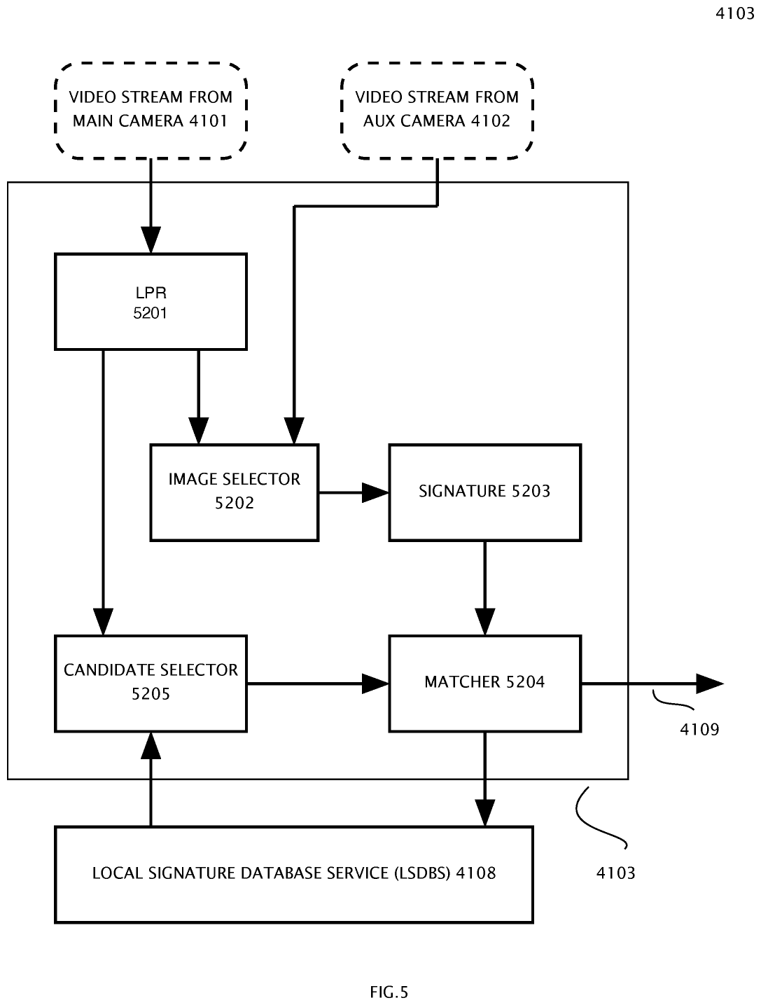

LPU 4103 comprises license plate reader (LPR) 5201, image selector 5202, signature evaluator 5203, matcher 5204 and candidate selector 5205. LPU 4103 is described in further detail below and in reference to FIG. 5.

LPR 5201 analyzes the sequence of images from the main camera 4101 and computes the plate reads for every incoming vehicle. For each incoming vehicle, it sends one event for further processing.

Image selector 5202 receives the event from LPR 5201 and obtains the best images from auxiliary camera 4102. As the main and auxiliary cameras 4101, 4102 are different physical units, they may not operate synchronously. It is necessary to obtain the best image from auxiliary cameras 4102 for signature evaluation, as opposed to images where vehicle images are only partially visible. The image selector 5202 module analyses a plurality of images from each auxiliary camera 4102 (separated by time offsets from one another) and determines the best image for signature evaluation.

Signature evaluator 5203 uses the chosen images from the plurality of cameras 4101, 4102 and evaluates the signature. The signature is separately evaluated for each perspective of vehicle. Matcher 5204 receives a license plate read and signature information to uniquely map the vehicle. Matcher 5204 receives the list of potential matches from candidate selector 5205. The result 4109, (including indicia of match/no match along with the vehicle signature and license plate read) is sent to CdPU 4105. If no matching score above the match threshold is found, matcher 5204 would indicate no-match status in 4109. Candidate selector 5205 performs the important function of reducing the list of potential candidates in order to improve the accuracy of matcher 5204 and reduce false positives. Candidate selector 5205 scores the potential candidates on a plurality of features including license plate reading divergence, distinctive features on license plate, and reduces the search space of matching candidates. The license plate read is picked from both main and auxiliary cameras 4101, 4102 from selected images. For example, the rear license plate as seen by main camera 4101 may be occluded, but the front license plate clearly visible. The distinctive features may include license plate reads, reading confidence, special embeddings on license plates, occlusion etc.

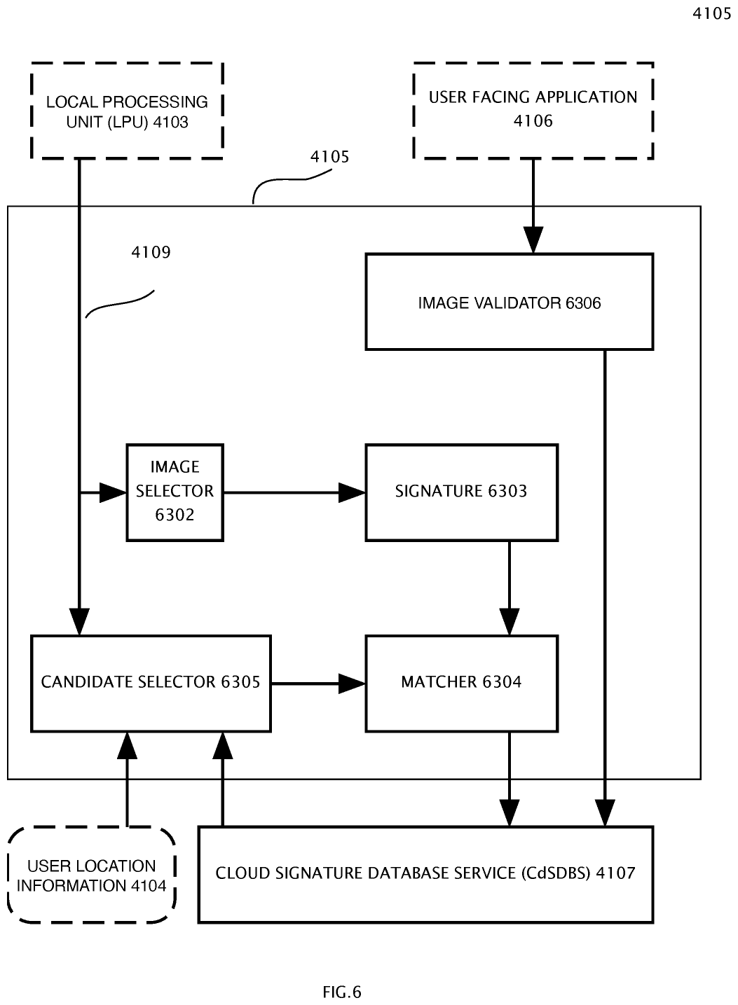

FIG. 6 depicts the component blocks that make up CdPU 4105. Image selector 6302, signature evaluator 6303, matcher 6304 and candidate selector 6305 are functionally similar to image selector 5202, signature evaluator 5203, matcher 5204 and candidate selector 5205. Candidate selector 6305, however, operates with an additional input of location information 4104, wherever available, to help reduce the search space of potential matching candidates. Image selector 6302, signature evaluator 6303, matcher 6304 and candidate selector 6305 are invoked whenever any of image selector 5202, signature evaluator 5203, matcher 5204 and candidate selector 5205 in LPU 4103 does not exist or failed to find a suitable match. They deploy a more generalized version of signature evaluation to support a variety of image quality and perspectives uploaded by the user. Having matched with a whitelisted user, using the user onboarded image, the updated signature (as evaluated by the edge camera) is updated to CdSDBS 4107.

LSDBS 4108 additionally queries CdSDBS 4107 for any updates to the signature. Only signatures evaluated using images from the edge cameras 4101, 4102 are updated back to LSDBS 4108.

Referring to FIG. 4, an exemplary embodiment of system 4000 includes CdSDBS 4107 00and LSDBS 4108 which receives updates from CdSDBS 4107. CdSDBS 4107 is coupled to CdPU 4105, and local signature database service is coupled to LPU 4103. In addition to LSDBS 4108, LPU 4103 receives a stream of video frames from a first (e.g., main) camera 4101 and a stream of video frames from a second (e.g., auxiliary) camera 4102. In addition to CdSDBS 4107, CdPU 4105 receives user location info 4104, input from user facing application 4106, and the results of transformations performed in LPU 4103, which are the vehicle event indicia 4109.

Referring to FIG. 5, local processing unit (LPU) 4103 is communicatively coupled to an external LSDBS 4108. The output 4109 of the LPU 4103 is transmitted to CdPU 4105. Each LPU 4103 receives a stream of video frame images from first (e.g., main) camera 4101 and a stream of video frame images from second (e.g., auxiliary) camera 4102. LPU 4103 includes a first Image selector 5202, which receives the stream of video frame image from first (e.g., main) camera 4101 and the stream of video frame images from second (e.g., auxiliary) camera 4102 after it has been transformed by license plate reader (LPR) component 5201. First candidate selector 5205 also receives the stream of video frame images from second (e.g., auxiliary) camera 4102 after it has been transformed by license plate reader (LPR) 5201 and input from LSDBS 4108. First signature selector 5203 transforms the result from the image selector 5202 and provides the resultant signature indicia to matcher 5204 which emits a result 4109 from the LPU 4103. Matcher 5204 receives input from candidate selector 5205 and also provides its result to LSDBS 4108.

FIG. 6 is a block diagram description of an exemplary CdPU 4105 in which components may be circuits or modules of executable instructions for a processor. CdPU 4105 is communicatively coupled to user-facing application 4106 and to an external CdSDBS 4107. CdPU 4105 includes matcher 6304 which receives input from a signature selector 6303 and from a second candidate selector 6305. Second signature selector 6303 receives input from a second image selector 6302. Separately, image validator 6306 of CdPU 4105 receives input from user-facing application 4106 and transmits to CdSDBS 4107 which also provides input to second candidate selector 6305. User location information 4104 is also provided to second candidate selector 6305. Additionally, second candidate selector 6305 and second image selector 6302 receive the output 4109 from LPU 4103.

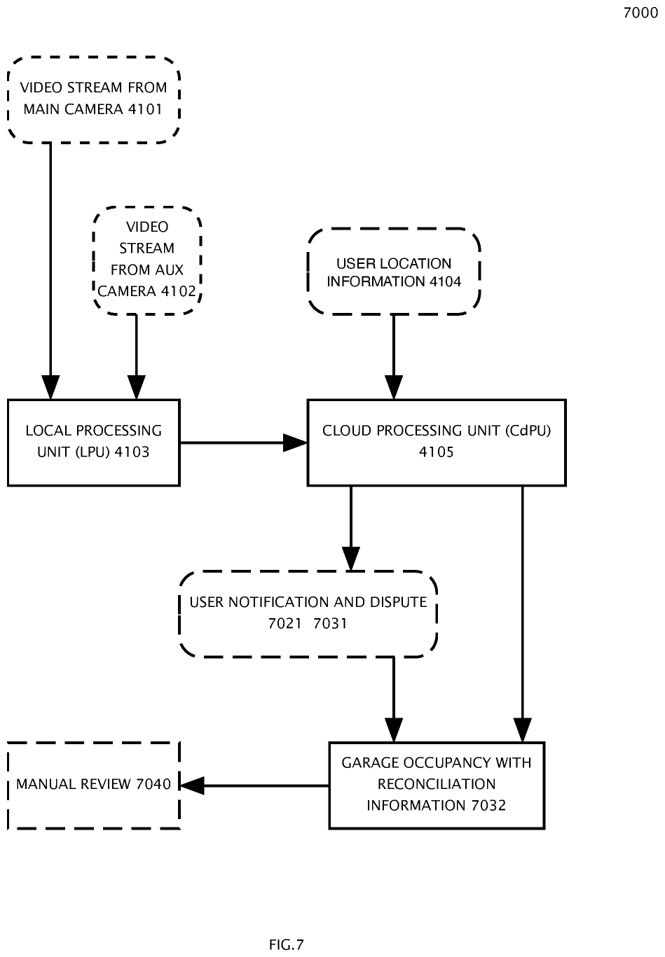

Referring to FIG. 7, LPU 4103 is coupled to a plurality of cameras 4101, 4102 to receive in an exemplary embodiment a front camera feed and a rear camera feed. LPU 4103 provides vehicle signature indicia and optical character recognition of a license plate to CdPU 4105. In an embodiment, the vehicle may provide a credential or location to CdPU 4105 wirelessly. CdPU 4105 provides a census of occupancy with reconciliation information which may be manually reviewed 7040. CdPU 4105 also emits a user notification 7021 which may initiate a user dispute 7031 of the charge, the vehicle, the location, or the date.

One aspect of the invention is a system which includes local processing unit (LPU) 4103 coupled to a plurality of cameras to receive a front camera feed and a rear camera feed. CdPU 4105 coupled to the LPU 4103 to receive vehicle signature indicia and optical character recognition of a license plate, whereby CdPU 4105 provides a census of garage occupancy with reconciliation information which may be manually reviewed. CdPU 4105 also emits a user notification which may initiate a user dispute of the charge, the vehicle, the location, or the date.

In an embodiment, the system also includes a wireless communication link to obtain vehicle location indicia, CdSDBS 4107, user-facing application 4106, and the results of transformations performed in LPU 4103 which are the vehicle event indicia.

In an embodiment, the system also includes a LSDBS 4108 which receives updates from CdSDBS 4107, wherein each of LSDBS 4108 and CdSDBS 4107 is coupled to its respective processing unit 4103, 4105.

In an embodiment, each LPU 4103 transmits output to CdPU 4105, upon each LPU 4103 receiving a stream of video frame images from a first (e.g., main) camera 4101 and a stream of video frame images from a second (e.g., auxiliary) camera 4102. LPU 4103 may include a first image selector 5202; which receives the stream of video frame image from first camera 4101 and a stream of video frame images from second camera 4102 after it has been transformed by a LPR. LPU 4103 may further include first candidate selector 5205, which also receives the stream of video frame images from second camera 4102 after it has been transformed by the License Plate Reader (LPR) and input from LSDBS 4108, first signature selector 5202 transforms the result of the image selector 5202; and provides the resultant signature indicia to a first matcher 5204 which emits a result from LPU 4103. Matcher 5204 receives input from first candidate selector 5205; and also provides its result to the external LSDBS 4108.

In an embodiment, CDPU 4105 may be circuits or modules of executable instructions for a processor. CDPU 4105 communicatively coupled to a user-facing application 4106 and to an external CdSDBS 4107. CDPU 4105 includes second matcher 6304 which receives input from a second signature selector 6303 and from a second candidate selector 6305. Second signature selector 6303 receives input from second image selector 6302. Image validator 6306 of CdPU 4105 receives input from user-facing application 4106 and transmits to CdSDBS 4107, which also provides input to second candidate selector 6305. User location information is also provided to second candidate selector 6305, wherein second candidate selector 6305 and second image selector 6302 component receive the output from first matcher 5204 of LPU 4103.

Building on the architecture of the system as disclosed above, one aspect of the invention is a method for tracking a vehicle departing a site as illustrated in the figures which includes having the processes as follows:

At step 3601, the method includes recognizing a license plate and determining a vehicle signature.

At step 3610, the method includes determining whether the license plate information matches information in a first database.

If, at step 3610, the license plate information matches information in a first database, then the method includes clearing the vehicle information from the first database at step 3611 and sending a notification at step 3651.

If, at step 3610, the license plate information does not match information in the first database, determining, at step 3620, when location information (e.g., GPS coordinates) is present.

If, at step 3620, embodiments determine location information is present, then at step 3621, the method includes obtaining position-time proximal candidates.

If, at step 3620, embodiments determine location information is not present, then at step 3630, the method includes obtaining license plate feature vector and identifying search candidates.

At step 3640, determining a signature match score among search candidates and proximal candidates.

At step 3650, determining when a best match score exceeds a threshold.

If, at step 3650, a best match score is less than or equal to a threshold score, then at step 3690, the method includes requesting a manual action.

If, at step 3650, a best match score exceeds a threshold score, then at step 3651, the method includes sending a notification.

At step 3660, determining whether the notification is disputed by a vehicle owner.

If, at step 3660, the notification is not disputed by the vehicle owner, then as step 3670, the process ends.

If, at step 3660, the notification is disputed by the vehicle owner, then at step 3690, requesting a manual action.

Building on the architecture of the system as disclosed above, another aspect of the invention is a method for tracking a vehicle entering a site includes the processes as illustrated in the figures as follows:

At step 2501, embodiments read a license plate and determine a vehicle signature.

At step 2510, embodiments determine whether license plate information read from a vehicle matches information for a whitelisted vehicle.

If, at step 2510, embodiments determine license plate information read from a vehicle matches information for a whitelisted vehicle, then at step 2511, the method includes onboarding a vehicle signature into a cloud store and, at step 2551, sending a notification.

If, at step 2510, embodiments determine license plate information read from a vehicle does not match information for a whitelisted vehicle, then at step 2520, the method includes determining when location information (e.g., global positioning satellites or GPS coordinates) is present.

If, at step 2510, embodiments determine license plate information read from a vehicle matches information for a whitelisted vehicle, then at step 2521, the method includes obtaining position-time proximal candidates.

If, at step 2510, embodiments determine license plate information read from a vehicle does not matches information for a whitelisted vehicle, then at step 2530, the method includes obtaining a license plate feature vector and identifying search candidates.

At step 2540, the method includes determining a signature match score among search candidates and proximal candidates.

At step 2550, the method includes determining whether a best match score exceeds a threshold.

If, at step 2550, embodiments determine a best match score does not exceed a threshold, then at step 2590, the method includes requesting a manual action.

If, at step 2550, embodiments determine a best match score does not exceed a threshold, then at step 2551, the method includes sending a notification.

At step 2560, the method may include determining whether the notification is disputed by a vehicle owner.

If, at step 2560, embodiments determine the notification is not disputed by a vehicle owner, then at step 2570, the process ends.

If, at step 2560, embodiments determine the notification is not disputed by a vehicle owner, then at step 2590, the process includes requesting a manual action.

### CONCLUSION

The invention can be easily distinguished from conventional systems by augmenting license plate information with vehicle signatures acquired by a wider field of view images. The invention is easily distinguished from conventional systems by enhancing LSDBS 4108 with updates from CdSDBS 4107 to overcome low quality of images or vehicle signatures taken locally. Conventional systems require wireless transponders. Conventional systems include cameras oriented to capture images of the vehicle operator.

The methodologies of embodiments of the disclosure may be particularly well-suited for use in an electronic device or alternative system. Accordingly, embodiments of the present invention may take the form of an entirely hardware embodiment or an embodiment combining software and hardware aspects that may all generally be referred to herein as a “processor,” “circuit,” “module” or “system.”

Furthermore, it should be noted that any of the methods described herein can include an additional step of providing a computer system implementing a method for anomaly alarm consolidation. Further, a computer program product can include a tangible computer-readable recordable storage medium with code adapted to be machine-executed to carry out one or more method steps described herein, including the provision of the system with the distinct software modules. One or more embodiments of the invention, or elements thereof, can be implemented in the form of an apparatus including a memory and at least one processor that is coupled to the memory and operative to perform exemplary method steps.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for determining vehicle information for the vehicle captured in a video stream matches vehicle information for a vehicle in a census of vehicles, the method comprising:
receiving a video stream from a camera;
determining the video stream captures a video image of a vehicle;
determining vehicle information for the vehicle captured in the video stream matches vehicle information for a vehicle in a census of vehicles comprising:
determining a vehicle signature for the vehicle based on the video stream;
reading a license plate in the video image to determine license plate information for the vehicle; and
determining one or more of the license plate information for the vehicle matches license plate information for a vehicle in a census of vehicles and the vehicle signature for the vehicle matches a vehicle signature for a vehicle in the census of vehicles.

2. The method of claim 2, wherein determining vehicle information for the vehicle captured in the video stream matches vehicle information for a vehicle in a census of vehicles comprises:
determining the license plate information matches license plate information stored in a local database service storing a portion of the census of vehicles; or
communicating the vehicle information including the license plate information and the vehicle signature to a cloud database service, wherein the cloud database service performs:
determining the license plate information for the vehicle matches license plate information for a vehicle in the census of vehicles.

3. The method of claim 2, wherein determining the license plate information comprises:
a local processing unit (LPU) executing a license plate reader (LPR) set of instructions for:
reading a license plate in each image of a plurality of images forming the video stream; and
selecting an image in the plurality of images with a best license plate read.

4. The method of claim 1, wherein determining vehicle information for the vehicle captured in the video stream matches vehicle information for a vehicle in a census of vehicles comprises:
determining whether the vehicle signature matches a vehicle signature stored in a local database service storing a portion of the census of vehicles; or
communicating the vehicle information including the license plate information and the vehicle signature to a cloud database service, wherein the cloud database service performs:
determining the vehicle signature for the vehicle matches a vehicle signature for a vehicle in the census of vehicles.

5. The method of claim 1, wherein:
the video stream comprises a first video stream;
the video image comprises a first video image;
the camera comprises a first camera;
the local database service comprises a first local database service;
the vehicle comprises a first vehicle; and
the method further comprises:
receiving a second video stream from a second camera;
determining the second video stream contains a video image of a second vehicle;
determining vehicle information for the second vehicle captured in the second video stream matches vehicle information for a second vehicle in the census of vehicles comprising:
determining a vehicle signature for the second vehicle based on the second video stream;
reading a second license plate in the second video image to determine license plate information for the second vehicle; and
determining one or more of the license plate information for the second vehicle matches the license plate information for the first vehicle and the second vehicle signature matches the first vehicle signature.

6. The method of claim 5, wherein the first camera is located at a first site of a plurality of sites and the second camera is located at a second site of the plurality of sites, wherein the first site is different from the second site.

7. The method of claim 5, wherein:
the vehicle information further comprises location information from a device executing an application; and
determining vehicle information for the vehicle captured in the video stream matches vehicle information for a vehicle in the census of vehicles comprises determining the device is a vehicle owner's device.

8. A system for determining vehicle information for the vehicle captured in a video stream matches vehicle information for a vehicle in a census of vehicles, the system comprising:
a local processing unit (LPU) configured to:
receive a video stream from a camera;
determine the video stream captures a video image of a vehicle;
determine vehicle information for the vehicle captured in the video stream matches vehicle information for a vehicle in a census of vehicles, wherein the LPU is configured to:
determine a vehicle signature for the vehicle based on the video stream;
read a license plate in the video image to determine license plate information for the vehicle; and
determine one or more of the license plate information for the vehicle matches license plate information for a vehicle in a census of vehicles and the vehicle signature for the vehicle matches a vehicle signature for a vehicle in the census of vehicles.

9. The system of claim 8, further comprising:
a local database service storing a portion of the census of vehicles; and
a cloud database service, wherein, to determine vehicle information for the vehicle captured in the video stream matches vehicle information for a vehicle in a census of vehicles, the LPU is configured to:
determine the license plate information matches license plate information stored in the local database service; or
communicate the vehicle information including the license plate information and the vehicle signature to the cloud database service,
wherein the cloud database service is configured to:
determine the license plate information for the vehicle matches license plate information for a vehicle in the census of vehicles.

10. The system of claim 9, wherein the local processing unit (LPU) executes a license plate reader (LPR) set of instructions to:
read a license plate in each image of a plurality of images forming the video stream; and
select an image in the plurality of images with a best license plate read.

11. The system of claim 8, further comprising:
a local database service storing a portion of the census of vehicles; and
a cloud database service, wherein
to determine vehicle information for the vehicle captured in the video stream matches vehicle information for a vehicle in a census of vehicles, the LPU is configured to:
determine whether the vehicle signature matches a vehicle signature stored in the local database service storing a portion of the census of vehicles; or
communicate the vehicle information including the license plate information and the vehicle signature to the cloud database service, wherein the cloud database service is configured to:
determine the vehicle signature for the vehicle matches a vehicle signature for a vehicle in the census of vehicles.

12. The system of claim 8, wherein:
the video stream comprises a first video stream;
the video image comprises a first video image;
the camera comprises a first camera;
the local database service comprises a first local database service;
the vehicle comprises a first vehicle; and
a cloud processing unit is configured to:
receive a second video stream from a second camera;
determine the second video stream contains a video image of a second vehicle;
determine vehicle information for the second vehicle captured in the second video stream matches vehicle information for a second vehicle in the census of vehicles comprising:
determine a vehicle signature for the second vehicle based on the second video stream;
read a second license plate in the second video image to determine license plate information for the second vehicle; and
determine one or more of the license plate information for the second vehicle matches the license plate information for the first vehicle and the second vehicle signature matches the first vehicle signature.

13. The system of claim 12, wherein the first camera is located at a first site of a plurality of sites and the second camera is located at a second site of the plurality of sites, wherein the first site is different from the second site.

14. The system of claim 12, wherein:
the vehicle information further comprises location information from a device executing an application; and
the LPU is configured to determine vehicle information for the vehicle captured in the video stream matches vehicle information for a vehicle in the census of vehicles comprises determining the device is a vehicle owner's device.
